(19) United States
(12) Patent Application Publication
(10) Pub. No.: US 2009/0051217 A1
(43) Pub. Date: Feb. 26, 2009

(54) SIDEKICK VEHICLE TRACK

(76) Inventors: Dennis Farwell, Beaverton, OR (US); Todd Kirdendall, Salem, OR (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/194,035

(22) Filed: Aug. 19, 2008

Related U.S. Application Data
(60) Provisional application No. 60/956,846, filed on Aug. 20, 2007.

(51) Int. Cl. B62D 55/24; B62D 55/18

(52) U.S. Cl. 305/165; 305/162

(57) ABSTRACT

An endless track for use with a vehicle, including a primary track section and at least one paddle is provided. The primary track section includes an upper surface, a lower surface, a first outer side and a second outer side. The paddle includes a first end and a second end, where the first end is operatively connected to the primary track section adjacent one of the sides. The paddle is non-perpendicular with respect to the primary track section such that the second end of the paddle is positioned outwardly away from the primary track section.

### CROSS REFERENCE TO RELATED APPLICATIONS

This application claims priority to U.S. provisional patent application 60/956,846, filed Aug. 20, 2007, which is incorporated by reference in its entirety.

### BACKGROUND INFORMATION

The present disclosure relates to an endless track for a vehicle, and in particular to an endless track that includes a primary track section and at least one paddle positioned adjacent to an outer side of the primary track portion.

### BRIEF SUMMARY OF THE INVENTION

Typically, an endless track for a vehicle such as a snowmobile will include a belt and a series of paddles or lugs located on the outside surface of the belt for propulsion and traction in snow. The arrangement of the lugs and their pitch depend on the specific type of riding activity that the snowmobile is designed to perform. Lugs with a shorter pitch and height are usually designed for groomed trails that have shallow snow conditions. Lugs with a taller height and wider pitch are designed for deeper snow conditions, such as mountain performance riding or trail riding on an ungroomed terrain.

The length of the endless track will vary depending on the type of riding activity as well. Longer tracks provide improved traction and flotation, and shorter tracks include increased speed and maneuverability. Tracks are usually made longer instead of wider for increased traction because an increase in width affects the steering ability of the snowmobile. As the track becomes longer, weight is added to the back end of the snowmobile, and affects acceleration, turning radius, maneuverability in shallow snow conditions and sled mobility.

Recent technologies have moved the driver to a forward position on the snowmobile in an effort to counterbalance the weight of the back end of the snowmobile due to the longer track. However, as the snowmobile is accelerated, the gravitational forces prevail and the load is distributed to the rear end. Moreover, typical track lengths have become so long (between ten to fourteen feet depending on the type of driving conditions) that there is a growing concern in the snowmobile industry that track lengths have reached their limit.

Therefore, when designing a snowmobile track, the pitch of the lugs, the length of the endless track, and the width of the endless track must be considered. These variables make it difficult, if not impossible, to design a single track that may be used for all types of snow conditions and riding activities using traditional approaches.

### BRIEF DESCRIPTION OF THE DRAWINGS

FIG. 1 is a partially cross sectional perspective view of a snowmobile including an endless track;

FIG. 1A is an enlarged, perspective view of Region 1A in FIG. 1;

FIG. 2 is an elevational view of the endless track, including a plurality of track segments;

FIG. 3A is a partial cross section of a portion of the endless track taken along lines 3-3 in FIG. 2;

FIG. 3B is an alternative illustration of the track segment in FIG. 3A;

FIG. 4A is an elevational perspective view of the track segment in FIG. 3A;

FIG. 4B is an alternative illustration of the track segment in FIG. 4A;

FIG. 4C is an enlarged, perspective view of Region 4C in FIG. 4B;

FIG. 5 is an elevational perspective view of the endless track in engagement with a drive wheel sprocket of a propulsion system of the snowmobile;

FIG. 6A is a partial cross section of a portion of an alternative illustration of the track segment;

FIG. 6B is an enlarged, exploded perspective view of a portion of the endless track, including the track segments, a pair of paddles, and the brackets; and

FIG. 7 is an elevational perspective view of a portion of an alternative illustration of the track segment.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

Moreover, there are a number of constants introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

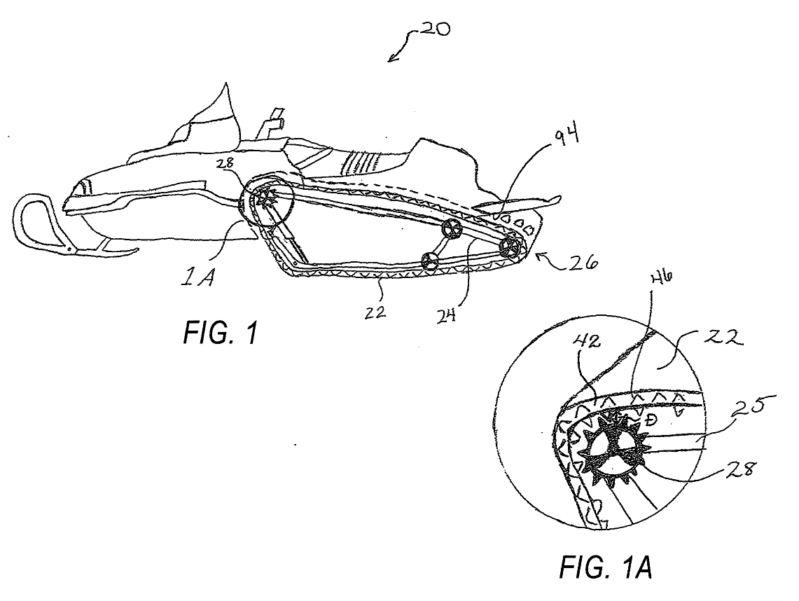

Turning now to the drawings and in particular to FIG. 1, an exemplar snowmobile 20 and an endless track 22 is disclosed. In the illustration of FIG. 1, the suspension 24 is connected to a propulsion system 26 of the snowmobile 20. The propulsion system 26 includes at least one drive wheel sprocket 28 for engagement with the endless track 22, which is discussed in greater detail below. It should be noted that while FIG. 1 illustrates the snowmobile 20 utilizing the endless track 22, any land vehicle for propulsion along a terrain may also include the endless track 22 as well, such as, but not limited to, an all terrain vehicle (ATV).

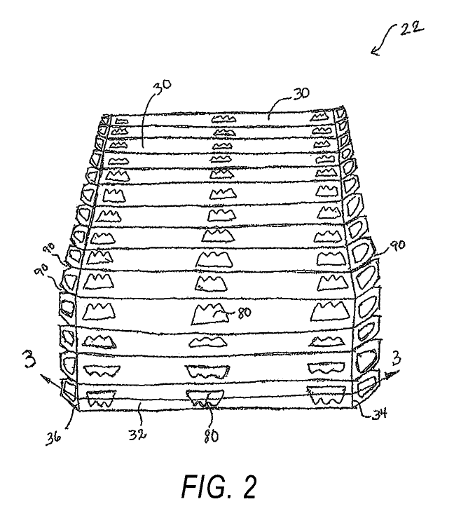

FIG. 2 illustrates the endless track 22 removed from the snowmobile 20. The endless track 22 includes a plurality of track segments 30. The track segments 30 are longitudinally spaced and may each include a lower surface 32, a first outer side 34 and a second outer side 36. Each of the track segments 30 is operatively connected to each other to form the endless track 22. Although FIG. 2 illustrates the endless track 22 constructed from a plurality of discretely formed track segments 30, the endless track 22 may also be constructed from an endless belt as well, in which case the segments 30 are not discretely formed.

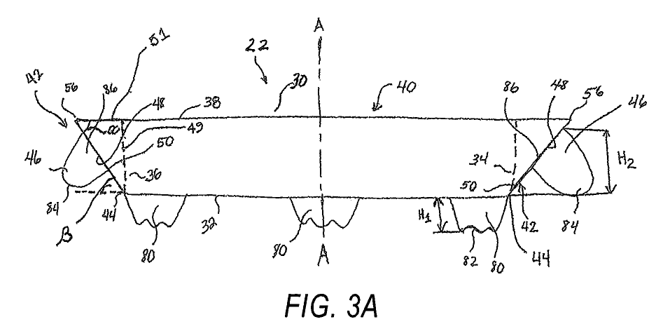

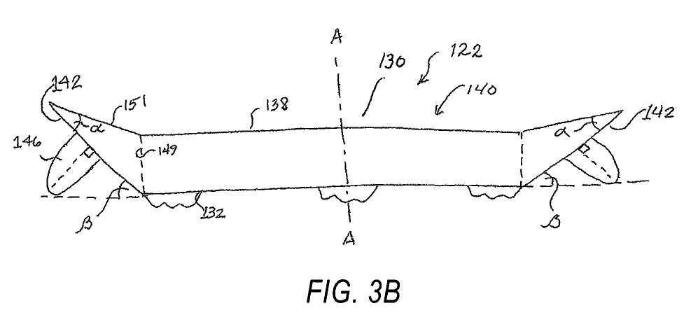

FIG. 3A is a partially cross sectioned view of the endless track 22. The endless track 22 also includes an upper surface 38. The upper surface 38, the lower surface 32, the first outer side 34 and the second outer side 36 make up a primary track section 40. At least one paddle 42 including a first end 44 and a second end 56 are operatively connected to the primary track section 40, adjacent one of the first outer side 34 and the second outer side 36. In one exemplary illustration, the paddle 42 is non-perpendicular with respect to the primary track section 40, such that the second end 56 of the paddle is positioned outwardly away from the primary track section 40. Moreover, the second end 56 is shown positioned outwardly from the first end 44.

The paddle 42 includes an outer surface 48, and inner surface 50, and is illustrated with at least one exemplary lug 46. The lug 46 is typically located along and extends outwardly from an outer surface 48 of the paddle 42. In one illustration, a plurality of lugs 46 is included on the outer surface 48.

As best seen in FIG. 3B, the lugs 146 are generally perpendicular to the outer surface 48 in an exemplary approach. However, as seen in FIG. 3A, the paddle 42 extends at an angle α defined between surfaces 38 and 48. The angle may vary both statically and in operation of endless track 22, but in one illustrative approach it is approximately forty five (45) degrees. In an exemplary illustration, surface 48 is also angled with respect to surface 32 as shown by angle β. The angle may vary both statically and in operation of endless track 22, but in one illustrative approach it is approximately forty five (45) degrees. Although FIG. 3A illustrates paddle 42 extending at angles α and β of forty-five (45) degrees, it is understood that paddle 42 may be oriented at a range of acute angles. Finally, while paddle 42 is shown generally triangular in cross-section in, the orientation is merely exemplary.

In FIG. 3A an upper surface 51 of paddle 42 is shown generally planar with respect to upper surface 38 of primary track section 40. An advantage of such an approach is to provide a robust attachment between paddle 42 and primary track section as shown by dashed line 49. Such an attachment provides resistance to flexing.

Alternatively, however, as shown in FIG. 3B, while still desiring a robust attachment as shown by dashed line 149, enhanced flexing may be desired. The upper surface 151 of the paddle 142 is not planar with respect to upper surface 138 of the primary track section 140. That is, the upper surface 151 extends upwardly from upper surface 138 of the primary track section 140. The upwardly extending upper surface 151 allows for an enhanced degree of flexing from the paddle 142.

As shown in FIG. 3A, the paddles 42 selectively provide an increased surface area of the primary track section 40 when the snowmobile 20 is propelled along a terrain. By including at least one paddle 42 adjacent to at least one of the first outer side 34 and the second outer side 36 of the primary track section 40, the effective surface area is selectively increased without widening the primary track section 40. Having two generally identical paddles 42 attached to opposing sides 34 and 36 provides even greater surface area while using the symmetry associated with line A-A as discussed further below to enhance the forward movement of endless track 22 about the propulsion system 26 as illustrated in an exemplary manner by sprocket 28.

More specifically, in deeper snow conditions, such as trail riding on an ungroomed terrain, the paddles 42 are in selective contact with the terrain. Alternatively, in shallower snow conditions, such as on a frozen lake that requires a narrower primary track section 40, the paddles 42 are typically not in selective contact with the terrain.

Providing an increased surface area of the primary track section 40 will also influence the center of mass of the snowmobile 20. A shorter endless track 22 will include a center of mass that is usually closer to the rider of the snowmobile 20, promoting increased maneuverability of the snowmobile 20. This is because snowmobile riders typically maneuver the snowmobile 20 using “body English.” Body English is movement by the rider to influence the physical mobility of the snowmobile 20. A center of mass located closer to the rider will allow for the rider to influence the movement of the snowmobile 20 more effectively than a track with a longer length. Thus, when the center of mass is located closer to the rider, greater maneuverability of the snowmobile 20 is generally achieved.

In one illustration, as best seen in FIG. 3A, two generally opposing paddles 42 form a generally trapezoidal-shaped profile with the primary track section 40. That is, the outer surfaces 48 and the upper surface 38 of the primary track section 40 define the trapezoidal shape in combination with lower surface 32. The paddles 42 extend at an angle away from the primary track section 40 and terminate at the second end 56. The paddles 42 and the primary track section 40 selectively define an axis of symmetry A. The axis of symmetry A is located generally perpendicular to the lower surface 32.

In one illustration, the endless track 22 including the generally opposing paddles 42 and the generally trapezoidal shape exhibits increased buoyancy when compared to an endless track without the paddles 42. That is, because the paddles 42 are elevated higher than the primary track section 40 the raised paddles provide flotation, similar to a hull design on a boat. Thus, the paddles 42 will increase the overall buoyancy of the snowmobile 20. This is advantageous because increased buoyancy of the snowmobile 20 translates into increased flotation in the snow. This means that a snowmobile with the paddles 42 along the primary track section 40, and with a generally trapezoidal-shaped profile will not get stuck in a snow bank as easily as a snowmobile without the paddles 42.

Yet another advantage of the endless track 22 including at least one paddle 42 is that paddle 42 selectively creates a barrier along at least of the first outer side 34 and the second outer side 36. The barrier blocks debris, such as dirt, mud or twigs from entering the primary track section 40. Critical suspension and propulsion components are located within the primary track section 40 and are extremely sensitive to friction or damage caused by contaminants or larger intrusions.

As illustrated in FIG. 1A, the paddles 42 extend past the drive wheel sprocket 28 of the propulsion system 26, at a distance D. The paddles 42 receive no support from a skidframe 25 of the snowmobile 20. Thus, the paddles 42 will be able to flex as the snowmobile turns corners, accelerates or rolls. For example, if the paddles 42 are angled at forty five degrees, as seen in FIG. 3A, when the primary track section 40 turns a corner the paddle 42 is selectively flexible at an angle of greater than forty five (45) degrees as the snowmobile 20 rolls off center.

In addition to the lugs 46 located along the outer surface 48, a plurality of lugs 80 are located along at least one of the track segments 30. As best seen in FIG. 2, the lugs 80 extend away from the lower surface 32 of the primary track section 40, and are positioned at predetermined locations along the lower surface 32 to form a desired pattern. Alternatively, the lugs 80 extend from random positions along the lower surface 32 as well. The lugs 80 are placed in selective engagement with the terrain, and are used for propulsion and traction. More specifically, the lugs 80 are selectively the first point of contact against snow as the snowmobile 20 is propelled along the terrain.

The lugs 46 are also in selective contact with the terrain. That is, the lugs 46 are typically in contact with the terrain during deeper snow conditions, such as trail riding on an ungroomed terrain. In one illustration as seen in FIG. 3A, a height H1 of the lug 80 extending from the lower surface 32 is measured from a free end 82 of the lug 80 to the lower surface 32. A height H2 of the lug 46 extending from the outer surface 48 of the paddle 42 is measured from a free end 84 of the lug 46 to a second end 86 operatively connected to the outer surface 48 of the paddle 42. As seen in FIG. 3A, the free end 82 of the lug 46 is aligned with the lower surface 32. Thus, when the snowmobile 20 is propelled along the terrain, the lugs 80 are selectively the first point of contact, and the terrain does not typically contact the lugs 46 that extend from the outer surface 48 in shallower snow conditions. However, in deeper snow conditions, when the terrain extends past the height H1 of the lugs 80, the snow contacts the lugs 46 along the outer surface 48 of the paddle 42.

The lugs 46 may also be used to propel the snowmobile 20 along the terrain by a sculling motion. More specifically, the lugs 46 perform a sweeping or pulling motion that propels the snowmobile 20 through the snow, without the direct weight of the snowmobile 20. The weight of the snowmobile 20 is selectively exerted on the lugs 80, which creates energy that the lugs 80 must overcome when propelling along the terrain. Unlike the lugs 80, the lugs 46 are located on at least one of the first outer side 34 and the second outer side 36 so the weight of the snowmobile 20 is not directly translated on the lugs 46. Because the pulling motion of the lugs 46 does not include the weight associated with the snowmobile 20, the lugs 46 have the ability to provide a buoyant, side sweeping motion along the snow.

The lugs 46 extending from the paddle 42 may also spray snow collected from the terrain along a top surface of a heat exchanger (not shown) of the snowmobile 20. As best seen in FIG. 1, the heat exchanger is usually located along an underside 94 of the snowmobile 20. That is, the lugs 46 from the angled paddle 42 selectively direct snow along the underside 94, and onto the heat exchanger of the snowmobile 20, unlike a conventional endless track. The snow spray will assist in cooling the heat exchanger. The enhanced cooling of the heat exchanger may increase engine life and performance.

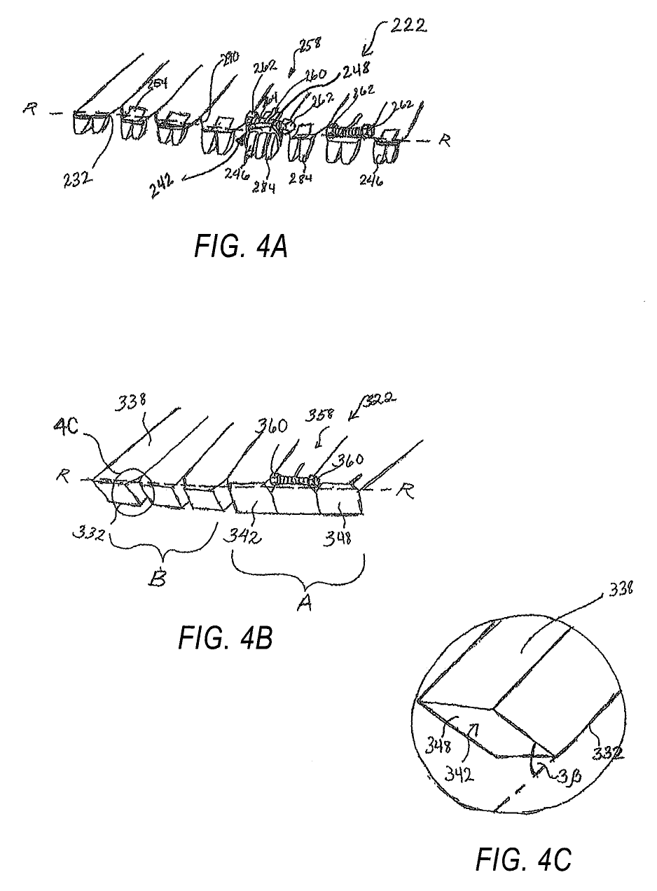

FIG. 4A is an alternative illustration of a portion of an endless track 222 including a plurality of lugs 246 extending from the paddle 242. At least one paddle 242 is selectively adjustable with respect to an axis of rotation R and the lower surface 232. In one illustration, a hinge 254 is located in part along the axis of rotation R to allow for the paddle 242 and the lug 246, located along the outer surface 248, to rotate. That is, the paddle 242 is selectively adjustable with respect to the axis of rotation R such that the free end 284 of the lug 246 is also allowed to rotate with respect to the lower surface 232. Although FIG. 4A illustrates the hinge 254 located along the axis of rotation R, it is understood the hinge 254 may also be a pivot point, or any other mechanism that allows for rotation.

A tensioner 258, such as a mechanical tensioning device including a sprung wire 260 is selectively used to mechanically adjust the angle of the paddle 242 and the lugs 246 located along the paddle 242. Two nuts 262 are threaded along a shank portion 264 to control the tension of the sprung wire 260. The nuts 262 are rotated until the desired tension is reached, and the tension is adjusted by rotating the nuts 262 along the shank portion 264.

In yet another alternative illustration, as seen in FIG. 4B, the paddle 342 does not include a lug. However, the paddle 342 is selectively adjustable with respect to the axis of rotation R such that the outer surface 348 selectively rotates with respect to the lower surface 332. The tensioner 358 is adjusted by rotating the nuts 362 along the shank portion 364, thereby allowing for the outer surface 348 to rotate.

The ability to orient the paddle 342 with respect to the axis of rotation R will allow for the user of the snowmobile 20 to adjust the endless track 322 for terrain, weather conditions, and snowmobile experience skill. For example, the ability to adjust the paddles 342 will allow for a novice rider to reduce the paddle 342 angle to be less than forty five degrees with respect to the lower surface 332 outwardly from the upper surface 338. Decreasing the angle of the paddle 342 will allow for earlier contact with the terrain as the snowmobile 20 rolls off center, thereby creating a safeguard that may be needed by a novice rider.

In addition to adjusting the paddle 342 for snowmobile experience skill and terrain, the paddle 342 is also adjustable for buoyancy of the endless track 322. That is, as best seen by FIG. 4C, when the angle 3β is selectively decreased, and the outer surface 348 of the paddle 342 is oriented closer to the lower surface 332, the buoyancy of the endless track 322 will increase. Similarly, when the angle 3β is selectively increased, the buoyancy of the endless track 322 will decrease. This is because angling the outer surface 348 closer to the lower surface 332 will allow for more effective surface area of the endless track 322 to be in selective contact with the terrain.

Indeed, as seen in FIG. 4B, the outer surface 348 is rotated from a first position A to a second position B that is closer to the lower surface 332 than the first position A. When the outer surface 348 is rotated to the second position B, the buoyancy of the endless track 322 is increased. When the effective surface area of the endless track 342 is increased, the buoyancy will also increase because the weight of the endless track 342 is distributed over a larger area over the terrain.

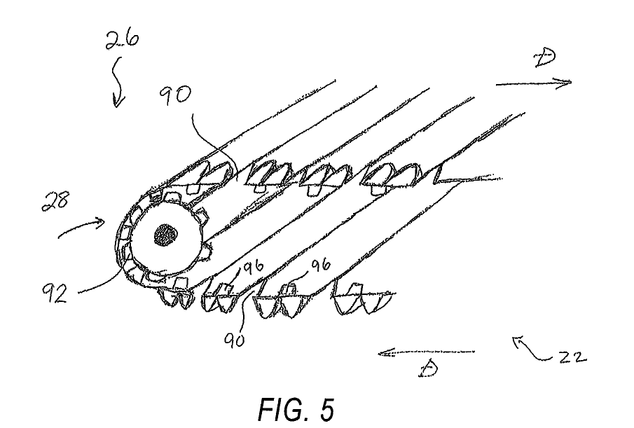

FIG. 5 illustrates the endless track 22 rotating in an operational direction D, with at least one notch 90 interposed between the track segments 30. The notches 90 are spaced at predetermined locations along the endless track 22. The notch 90 allows for greater flexibility of the paddles 42 as the endless track rotates along the propulsion system 26. More specifically, the notch 90 will assist in flexibility of the paddle 42 when the endless track 22 rotates around the drive wheel sprocket 28. It should be noted that while FIG. 5 illustrates the notch 90 as having a generally triangular profile, the profile may also be circular or rectangular as well. However, the use of triangular profiles for the notch 90 will result in the greatest amount of surface area of the paddles 42.

A plurality of nubs 96 are included along the upper surface 38, and engage with the teeth 92 of the drive wheel sprocket 28. Thus, the nubs 96 facilitate the rotation of the endless track 22 in the operational direction D.

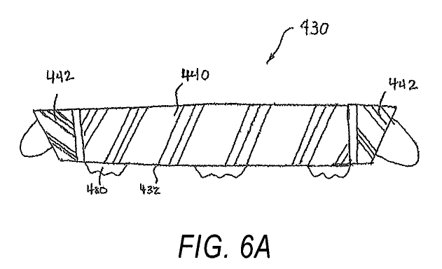

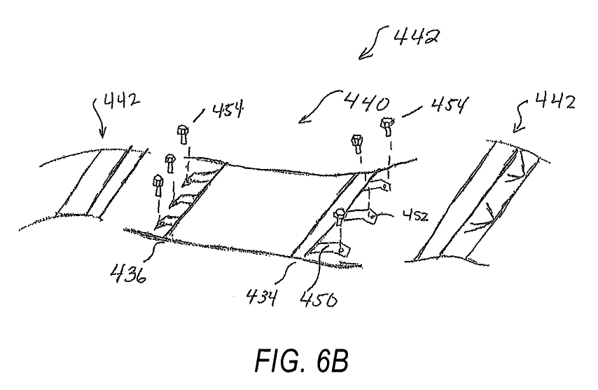

In an alternative illustration, the primary track section 440 and the paddle 442 of the track segment 430 are constructed from different materials. That is, as seen in FIG. 6A, the primary track section 440 is composed of a first material and the paddle 442 is constructed from a second material. The primary track section 440 and the paddle 442 are constructed of a rubber material, where the paddle 442 includes a rubber with a softer durometer than the primary track section 440. The softer durometer rubber will allow for the paddle 442 to flex at an angle when the primary track section 440 accelerates, turns a corner and the snowmobile 20 rolls off center. A higher durometer rubber typically allows for the lugs 480 extending from the lower surface 432 of the primary track section 440 to penetrate ice and hard packed snow.

One method of assembling the endless track 422 is shown in FIG. 6B, illustrating a section of the primary track section 440 and a section of the paddles 442. The primary track section 440 includes a series of brackets 450 with angled ends. The paddle 442 is attached to the primary track section 440 at the brackets 450. The brackets 450 include holes 452 that allow for a set of bolts 454 to fasten the paddles 442 to the primary track section 440. Preferably, the brackets 450 should extend along the primary track section 440 and attach to the paddles 442 at both of the first outer side 434 and the second outer side 436.

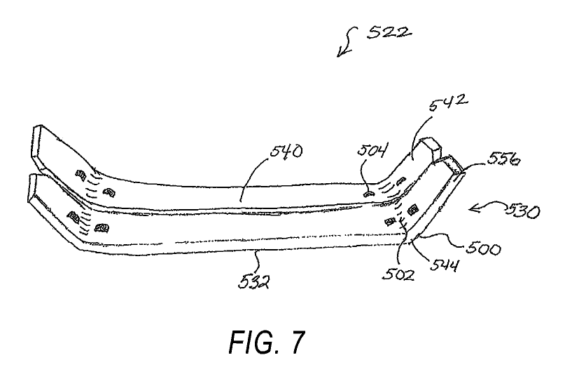

In yet another alternative illustration, as seen in FIG. 7, the primary track section 540 and the paddle 542 are constructed from a single, elongated member 500. That is, at least one of the track segments 530 of the endless track 522 is constructed from the elongated member 500. The first end 544 of the paddle 542 is the bend 502 in the elongated member 500. The bend 502 upwardly extends from the lower surface 532 towards the second end 556 of the paddle 542. A stabilizer 504 is typically used to retain the bend 502 along the elongated member 500.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

We claim:

1. An endless track for use with a vehicle, comprising:
a primary track section including an upper surface, a lower surface, a first outer side and a second outer side; and
at least one paddle including a first end and a second end, where said first end is operatively connected to said primary track section adjacent one of said sides; and
wherein said paddle is non-perpendicular with respect to said primary track section such that said second end of said paddle is positioned outwardly away from said primary track section.

2. The endless track as recited in claim 1, said paddle including an outer surface and an inner surface, wherein said paddle is selectively adjustable with respect to an axis of rotation such that said outer surface selectively rotates with respect to said lower surface.

3. The endless track as recited in claim 2, wherein said outer surface rotates between a first position to a second position that is closer to said lower surface than said first position, and said second position provides a greater buoyancy for said endless track than said first position.

4. The endless track as recited in claim 1, said paddle including an outer surface and an inner surface, and further including at least one lug located along and extending away from said outer surface of said paddle.

5. The endless track as recited in claim 4, wherein said lug is generally perpendicular to said outer surface.

6. The endless track as recited in claim 4, wherein said paddle is selectively adjustable with respect to an axis of rotation such that a free end of said lug selectively rotates with respect to said lower surface.

7. The endless track as recited in claim 6, further comprising one of a hinge and a pivot point located at least in part along the axis of rotation of said paddle.

8. The endless track as recited in claim 6, further comprising a tensioner for selectively adjusting said free end of said lug with respect to said lower surface.

9. The endless track as recited in claim 1, said paddle including an outer surface and an inner surface and further including a plurality of lugs located along and extending away from said outer surface of said paddle.

10. The endless track as recited in claim 1, wherein at least one notch is spaced at a predetermined location along the endless track.

11. The endless track as recited in claim 10, wherein said notch is one of a triangular, circular and a rectangular profile.

12. The endless track as recited in claim 1, wherein said primary track section is constructed from a first material, and said paddle is constructed from a second material.

13. The endless track as recited in claim 1, further comprising a plurality of paddles, said paddles and said primary track portion forming a generally trapezoidal-shaped profile.

14. The endless track as recited in claim 13, wherein said paddles and said primary track portion define an axis of symmetry.

15. The endless track as recited in claim 1, wherein said paddle is angled at about forty five degrees with respect to said lower surface outwardly away from said upper surface.

16. The endless track as recited in claim 1, wherein said paddle selectively provides an increased surface area of said track when the snowmobile is propelled along a terrain.

17. The endless track as recited in claim 1, further comprising a plurality of lugs located along said endless track and extending away from said lower surface of said primary track section.

18. The endless track as recited in claim 17, wherein said lugs are positioned at predetermined locations along said lower surface to form a desired pattern.

19. The endless track as recited in claim 1, wherein said primary track section and said paddle are constructed from a single, elongated member.

20. An endless track for use with a land vehicle, including a plurality of track segments, at least one of the track segments comprising:
a primary track section including an upper surface, a lower surface, a first outer side and a second outer side;
two generally opposing paddles, each including an outer surface and an inner surface, a first end and a second end, where said first end of one of said paddles is operatively connected to said primary track section adjacent said first outer side, the other of said paddles operatively connected to said primary track section adjacent said second outer side; and
at least one lug secured to at least one of said paddles and extending away from said outer surface;
wherein said paddles extend at an angle away from said primary track section and terminate at said second ends, thereby defining a generally trapezoidal shape defined by each of said outer surfaces of paddles and said upper surface of said primary track section.

21. The endless track as recited in claim 20, further including a plurality of lugs located along and extending away from said outer surface of said paddles.

22. The endless track as recited in claim 20, wherein said lugs are generally perpendicular to said outer surface.

23. The endless track as recited in claim 20, wherein said outer surface of said paddles are selectively adjustable with respect to an axis of rotation such that a free end of said lugs selectively rotates with respect to said lower surface.

24. The endless track as recited in claim 23, wherein said outer surface rotates between a first position to a second position that is closer to said lower surface than said first position, and said second position provides a greater buoyancy for said endless track than said first position.

25. The endless track as recited in claim 23, further comprising one of a hinge and a pivot point located at least in part along the axis of rotation of said paddles.

26. The endless track as recited in claim 23, further comprising a tensioner for selectively adjusting said free end of said lugs with respect to said lower surface.

27. The endless track as recited in claim 20, wherein at least one notch is interposed between adjacent track segments.

28. The endless track as recited claim 27, wherein said notch is one of a triangular, circular and a rectangular profile.

29. The endless track as recited in claim 20, wherein said primary track section is constructed from a first material, and said paddle is constructed from a second material.

30. The endless track as recited in claim 20, wherein said paddles and said primary track portion define an axis of symmetry.

31. The endless track as recited in claim 20, wherein said paddle is angled at about forty five degrees with respect to said lower surface outwardly away from said upper surface.

32. The endless track as recited in claim 20, wherein said paddle selectively provides an increased surface area of said track when the land vehicle is propelled along a terrain.

33. The endless track as recited in claim 20, further comprising a plurality of lugs located along least one of said track segments and extending away from said lower surface of said primary track section.

34. The endless track as recited in claim 33, wherein said lugs are positioned at a predetermined location along said lower surface to form a desired pattern.

35. The endless track as recited in claim 20, wherein said primary track section and said paddles are constructed from a single, elongated member.

36. A track segment for use with an endless track for use with a land vehicle, the track segment comprising:
a primary track section including an upper surface, a lower surface, a first outer side and a second outer side;
two generally opposing paddles, each including an outer surface and an inner surface, a first end and a second end, where said first end of one of said paddles is operatively connected to said primary track section adjacent said first outer side, the other of said paddles operatively connected to said primary track section adjacent said second outer side; and
at least one lug including a free end, said lug secured to at least one of said paddles and extending away from said outer surface;
wherein said paddles extend at an angle away from said primary track section and terminate at said second ends, thereby defining a generally trapezoidal shape defined by each of said outer surfaces of paddles and said upper surface of said primary track section;
wherein said paddles are selectively adjustable with respect to an axis of rotation such that a free end of said lug selectively rotates with respect to said lower surface.

37. The track segment as recited in claim 36, further including a plurality of lugs located along and extending away from said outer surface of said paddles.

38. The track segment as recited in claim 36, further comprising one of a hinge and a pivot point located at least in part along the axis of rotation of said lugs.

39. The track segment as recited in claim 36, further comprising a tensioner for adjusting said free end of said lugs with respect to said outer surface.

40. The track segment as recited in claim 36, further including an adjacent track segment, wherein at least one notch is interposed between adjacent track segments.

41. The track segment as recited in claim 40, wherein said notch is one of a triangular, circular and a rectangular profile.

42. The track segment as recited in claim 36, wherein said primary track section is constructed from a first material, and said paddle is constructed from a second material.

43. The track segment as recited in claim 36, wherein said paddles and said primary track portion define an axis of symmetry.

44. The track segment as recited in claim 36, wherein said paddle is angled at about forty five degrees with respect to said lower surface outwardly away from said upper surface.

45. The track segment as recited in claim 36, wherein said paddle selectively provides an increased surface area of said track when the snowmobile is propelled along a terrain.

46. The endless track as recited in claim 36, further comprising a plurality of lugs located along least one of said track segments and extending away from said lower surface of said primary track section.

47. The endless track as recited in claim 46, wherein said lugs are positioned at a predetermined location along said lower surface to form a desired pattern.

48. The endless track as recited in claim 36, wherein said outer surface of said paddles rotates between a first position to a second position that is closer to said lower surface than said first position, and said second position provides a greater buoyancy for said endless track than said first position.
